(19) United States
(12) Patent Application Publication
(10) Pub. No.: US 2022/0412392 A1
(43) Pub. Date: Dec. 29, 2022

(54) MULTIFUNCTIONAL FASTENER

(71) Applicant: Kenrick Alexander Brown, Georgetown, TX (US)

(72) Inventor: Kenrick Alexander Brown, Georgetown, TX (US)

(21) Appl. No.: 17/742,094

(22) Filed: May 11, 2022

Related U.S. Application Data
(60) Provisional application No. 63/214,622, filed on Jun. 24, 2021.

(51) Int. Cl. F16B 39/24; F16B 35/00

(52) U.S. Cl. CPC F16B 39/24; F16B 35/00

(57) ABSTRACT

A multifunctional fastener is provided which is easy to install and combines a screw, and a washer and/or a wing assembly. The multifunctional fastener may include a fastener head. A threaded portion may extend longitudinally and distally of the fastener head. A fastener washer may be disposed between the fastener head and the threaded portion, and may extend radially outward of the fastener head. The wing assembly may include at least one fastener wing extending radially outward from the fastener head, and preferably radially outward of the fastener washer. A torque-applying tool connector may be provided in the fastener head. The torque-applying tool connector may be configured for engagement with a torque-applying tool such as a manual screwdriver or electric drill screwdriver to facilitate rotation of the threaded portion via the fastener head.

### CROSS REFERENCE TO RELATED APPLICATIONS

This application claims priority under 35 U.S.C. § 119 to U.S. Provisional Application No. 63,214,622 entitled, “Multifunctional Fastener,” filed Jun. 24, 2021, and hereby expressly incorporated by reference herein.

### FIELD

The present application relates generally to screws, bolts and like mechanical fasteners, and more particularly, to a multifunctional fastener which is easy to install and combines a screw, and at least one of a washer and at least one wing.

### BACKGROUND

Fasteners such as screws, bolts, nails, anchors, and the like are commonly used to secure objects to a support or the ground. Conventional fasteners may be permanently or temporarily installed. In the building industry, screws and bolts are frequently used to secure materials to a support. The type of fastener used in a particular application is typically dependent on the type of materials being fastened together. Accordingly, various types of fasteners which are suitable for a particular application have been designed to simplify labor and time during construction.

Homeowners typically hang pictures, shelves, plants, and other decorations or furniture items on their interior walls. Picture hangers typically use a nail and a holding bracket which supports the hanger and includes an opening for passage of the nail. However, the nail can be easily pulled from the wall, particularly if heavy pictures are supported by the hanger. Larger fastening devices may be unsightly and oversized for the application at hand.

Screws are one of the most common types of fasteners. A conventional screw may include a head from which an elongated shaft or shank extends. A thread extends in a helicoidal configuration along the exterior of the shank. The distance between each run of the thread on the same side of the shank is known as the “pitch”. Furthermore, the thread may vary in height, width, and shape. In different types of screws, the shank may be fully threaded or partially threaded.

The head of the screw enables the shank to be rotated by engagement of a torque-applying tool such as a screwdriver, wrench, or electric drill screwdriver with the head. The head is typically larger than the shank of the screw to prevent the screw from being driven deeper than the length of the shank into the fastened material. The thread provides an inclined plane which imparts a wedging action to the shank to force the shank of the screw through the fastened material and into the support.

Most screws have right-hand threads and are tightened by clockwise rotation and loosened by counterclockwise rotation of the screw. Screws with left-hand threads may be used in cases in which a secured load may otherwise tend to loosen a right-hand fastener. For example, in applications in which the screw will be subject to counterclockwise torque that would otherwise loosen a screw having a right-hand thread, a screw with a left-hand thread would be necessary. thread.

Various types of screws have been developed for different types of materials such as wood, sheet metal, plastic, and drywall. For example, a drywall screw may have a body of constant diameter and threads configured to cut into the dry wall and the fixture to which the drywall is mounted. Some types of screws are self-tapping, meaning that as the screw is rotated, the screw thread cuts an internal thread into the material that helps pull the fastened material against the support and prevents the screw from pulling out. Carriage bolts have a domed head and are not designed to be driven. Set screws typically have a head which is smaller than the outer diameter of the shank. J-bolts have a J-shaped head that is not designed to be driven but rather is usually sunk into concrete allowing it to be used as an anchor bolt.

A drawback which is commonly encountered using conventional screws, bolts and like fasteners is that the fasteners may be unstable and inadequate to support heavy loads. In addition, conventional fasteners may also loosen over time. Some types of conventional fasteners may be difficult to install, particularly for those who lack the skills or tools required for installation. Furthermore, the screws may need to be installed with a washer and/or an anchor, which may render installation more difficult and cumbersome.

Accordingly, there is need for a multifunctional fastener which is easy to install and solves at least one of the aforementioned problems.

### SUMMARY

The present invention is directed to a multifunctional fastener which is easy to install and combines a screw, and at least one of a washer and a wing assembly. The multifunctional fastener may include a fastener head. A threaded portion may be arranged in a longitudinal direction and distally of the fastener head. The fastener washer may be disposed between the fastener head and the threaded portion, and may extend radially outward of the fastener head. The wing assembly may include at least one fastener wing extending outward from the fastener head, and preferably radially outward of the fastener washer. A torque-applying tool connector may be provided in the fastener head. The torque-applying tool connector may be configured for engagement with a torque-applying tool to facilitate rotation of the threaded portion via the fastener head.

In a second aspect, the multifunctional fastener may be fabricated in different sizes.

In another aspect, the multifunctional fastener may be fabricated of different materials.

In a second aspect, the fastener head may include a proximal surface and a sidewall extending distally from the proximal surface.

In another aspect, the torque-applying tool connector may extend into the proximal surface of the fastener head.

In another aspect, the torque-applying tool connector may include at least one blade slot.

In another aspect, the torque-applying tool connector may be configured to accommodate a flat blade on the screwdriver.

In another aspect, the torque-applying tool connector may be configured to accommodate a Phillips head blade on the screwdriver.

In another aspect, the torque-applying tool connector may protrude from the proximal surface of the fastener head.

In another aspect, the sidewall of the fastener head may be cylindrical.

In another aspect, the wing assembly may include a collar disposed over the fastener head, and the fastener wings may extend outwardly from the collar.

In another aspect, the fastener wings of the wing assembly may be disposed in substantially 180-degree relationship to each other on opposite sides of the multifunctional fastener.

In another aspect, the collar of the wing assembly may be fabricated in one piece with the sidewall of the fastener head.

In another aspect, the collar of the wing assembly may be attached to the sidewall of the fastener head using welding and/or other attachment technique.

In another aspect, the collar of the wing assembly may have a proximal edge proximate the proximal surface of the fastener head, a distal edge spaced-apart and parallel to the proximal edge of the collar and an outer surface extending from the proximal edge of the collar to the distal edge of the collar.

In another aspect, each fastener wing of the wing assembly may extend outwardly from the outer surface of the collar.

In another aspect, each fastener wing of the wing assembly may span the distance from the proximal edge to the distal edge of the collar.

In another aspect, each fastener wing of the wing assembly may include an inner edge extending along the junction between the outer surface of the collar and the fastener wing, and an outer edge parallel and spaced-apart to the inner edge of the fastener wing.

In another aspect, each fastener wing of the wing assembly may include a proximal edge and a distal edge extending from the inner edge of the fastener wing to the outer edge of the fastener wing in parallel, spaced-apart relationship to each other.

In another aspect, the fastener wing may include a pair of opposite side surfaces extending from and between the inner edge of the fastener wing, the outer edge of the fastener wing, the proximal edge of the fastener wing and the distal edge of the fastener wing.

In another aspect, the proximal edge and the distal edge of each fastener wing may be substantially flush with the proximal edge and the distal edge, respectively, of the collar.

In another aspect, the fastener washer may include a proximal surface at the distal edge of the collar, a distal surface spaced-apart and parallel to the proximal surface of the fastener washer, and an outer edge extending from the proximal surface of the fastener washer to the distal surface of the fastener washer.

In another aspect, each fastener wing of the wing assembly may extend radially outward beyond the outer edge of the fastener washer. The outer edge of the fastener washer may be disposed farther radially outwardly than the sidewall of the fastener head.

In another aspect, the fastener washer may have a width or diameter which is greater than a width or diameter of the fastener head.

In another aspect, the threaded portion may include a shank which extends from the distal surface of the fastener washer and a fastener thread extending from the shank.

In another aspect, the shank may have a proximal end at the distal surface of the fastener washer, a distal end opposite the proximal end of the shank, and the fastener thread may extend from the shank at least partially between the proximal end and the distal end of the shank.

In another aspect, the distal end of the shank may be pointed.

In another aspect, the fastener thread may extend along at least part of the distance between the proximal end and the distal end of the shank.

In another aspect, the fastener thread may extend substantially the entire distance from the proximal end to the distal end of the shank.

In another aspect, the fastener thread may be tapered V-threads.

These and other objects, features, and advantages of the present invention will become more readily apparent from the attached drawings and the detailed description of the preferred embodiments, which follow.

### BRIEF DESCRIPTION OF THE DRAWINGS

The preferred embodiments will hereinafter be described in conjunction with the appended drawings provided to illustrate and not to limit the invention, where like designations denote like elements, and in which:

FIG. 1 presents a proximal, isometric view of a multifunctional fastener in accordance with an illustrative embodiment;

FIG. 2 presents a distal, isometric view of an embodiment of the multifunctional fastener illustrated in FIG. 1;

FIG. 3 presents a side elevation view of an embodiment of the multifunctional fastener of FIG. 1;

FIG. 4 presents a proximal elevation view of an embodiment of the multifunctional fastener of FIG. 1;

FIG. 5 presents a distal elevation view of an embodiment of the multifunctional fastener of FIG. 1;

FIGS. 6A-F present side elevation views of various embodiments of the tool connector of the multifunctional fastener of FIG. 1;

FIGS. 7A-B present side elevation views of various embodiments of the wing assembly of the multifunctional fastener of FIG. 1;

FIGS. 8A-F present distal elevation views of embodiments of the threaded portion 160 of the multifunctional fastener of FIG. 1;

FIGS. 9A-B present a side elevation view of an embodiment of the multifunctional fastener of FIG. 1 with a fastening hook; and

FIG. 10 presents a proximal, isometric view of the multifunctional fastener of FIG. 1 with a detachable wing assembly.

Like reference numerals refer to like parts throughout the several views of the drawings.

### DETAILED DESCRIPTION

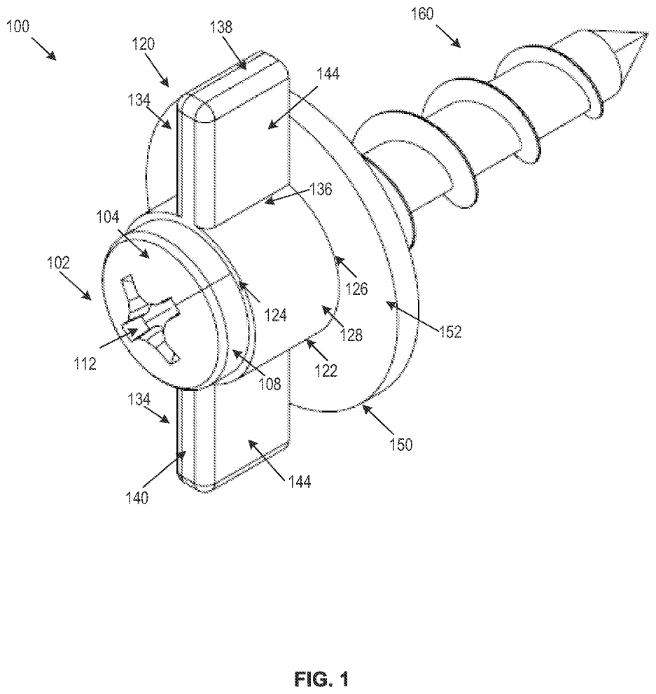

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present application is directed toward a multifunctional fastener which is easy to install and combines a screw, and at least one of a washer and a wing assembly.

Referring initially to FIG. 1, a multifunctional fastener 100 is illustrated in accordance with an exemplary embodiment. As shown, the multifunctional fastener 100 may include a fastener head 102. A threaded portion 160 may extend distally relative to the fastener head 102. In some embodiments, a fastener washer 150 may be disposed between the fastener head 102 and the threaded portion 160. Alternatively or additionally, the multifunctional fastener 100 may include a wing assembly 120, which may comprise at least one wing 134 extending outwardly, and preferably radially outwardly, from the fastener head 102. In some embodiments, such as the present embodiment, the wing assembly 120 more preferably includes a pair of fastener wings 134, which may extend radially outward of the fastener head 102 in angularly-spaced-apart relationship to each other, and more preferably, in a diametrically opposed relationship with each other. A torque-applying tool connector 112 may be provided in the fastener head 102.

The multifunctional fastener 100 may be fabricated in different sizes depending on the application. The multifunctional fastener 100 may be fabricated of different materials such as metal, plastic and/or composite materials, for example and without limitation.

In some embodiments, the toque-applying tool connector 112 may take the form of a female connector or cavity formed into the fastener head 102, for inserting a torque-applying tool (e.g., a screwdriver shaft) thereinto and applying a torque to the fastener head 102. For example, the fastener head 102 of the multifunctional fastener 100 may include a proximal surface 104, arranged longitudinally opposite to the threaded portion 160, and the torque-applying tool connector 112 may extend into the proximal surface 104 of the fastener head 102. In some embodiments, the torque-applying tool connector 112 may have intersecting blade slots configured to accommodate a Phillips head blade on the screwdriver.

The fastener 100 may further include a sidewall 108 which may extend distally from the proximal surface 104 of the fastener head 102. In some embodiments, the sidewall 108 of the fastener head 102 may be cylindrical. In other embodiments, the sidewall 108 may have a square, hexagonal, octagonal, or other polygonal shape.

The fastener wings 134 of the wing assembly 120 may extend outwardly with respect to the sidewall 108 of the fastener head 102. In some embodiments, the wing assembly 120 may include a collar 122. The collar 122 of the wing assembly 120 may be disposed over the fastener head 102. The fastener wings 134 may be affixed to and extend outwardly from the collar 122. The fastener wings 134 may be disposed in substantially 180-degree relationship to each other on opposite sides of the collar 122.

In some embodiments, the collar 122 of the wing assembly 120 may be fabricated in one piece with the sidewall 108 of the fastener head 102. In some embodiments, the collar 122 of the wing assembly 120 may be attached to the sidewall 108 of the fastener head 102 using welding and/or other attachment technique. The collar 122 of the wing assembly 120 may have a proximal edge 124 proximate the proximal surface 104 of the fastener head and a distal edge 126 longitudinally spaced-apart and optionally parallel to the proximal edge 124. An outer surface 128 of the collar 122 may extend from the proximal edge 124 to the distal edge 126.

Each fastener wing 134 of the wing assembly 120 may extend outwardly from the outer surface 128 of the collar 122. In some embodiments, each fastener wing 134 of the wing assembly 120 may span the distance from the proximal edge 124 to the distal edge 126 of the collar 122. Though not shown, in some embodiments, each fastener wing 134 may span the distance of the fastener washer 150 to the proximal surface 104 of the fastener head 102, to further increase the size of the fastener wing 134.

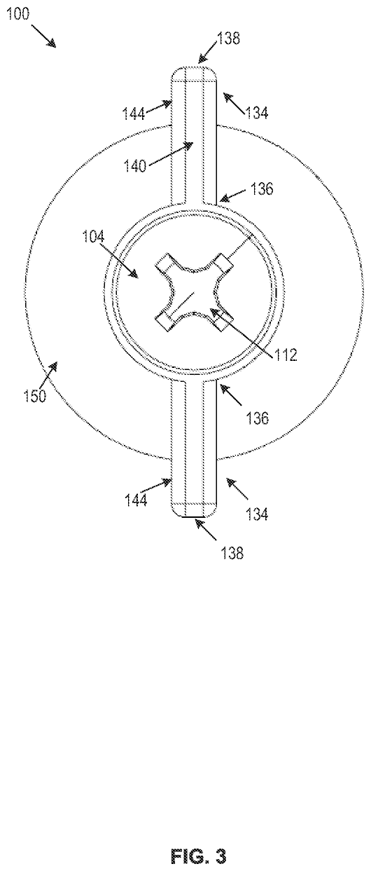

With reference to FIG. 3, each fastener wing 134 of the wing assembly 120 may include an inner edge 136. An outer edge 138 may extend in parallel, spaced-apart relationship to the inner edge 136; in other embodiments, the outer edge 138 may present alternative shapes such as, but not limited to, outwardly curved or convex. The inner edge 136 may extend along the junction between the outer surface 128 of the collar 122 and the fastener wing 134.

Each fastener wing 134 of the wing assembly 120 may further include a proximal edge 140 and a distal edge 142. The proximal edge 140 and the distal edge 142 may extend from the inner edge 136 to the outer edge 138. In some embodiments, the proximal edge 140 and the distal edge 142 may be arranged in parallel, spaced-apart relationship to each other; however, alternative geometries are contemplated, such as having the proximal edge 140 slightly tapered or oblique. In some embodiments, the proximal edge 140 and the distal edge 142 of each fastener wing 134 may be substantially flush with the proximal edge 124 and the distal edge 126, respectively, of the collar 122.

A pair of opposite wing sides or side surfaces 144 may be bound by the inner edge 136, the outer edge 138, the proximal edge 140 and the distal edge 142 of each fastener wing 134. In some embodiments, such as the present embodiment, the opposite side surfaces 144 may be generally flat and parallel to one another; however, alternative embodiments are contemplated, such as having one or both side surfaces 144 include a non-flat geometry, such as to increase ergonomics, and/or a non-smooth texture or ruggedness, such as for said one or both side surfaces 144, to provide a gripping surface with decreased slip to the user.

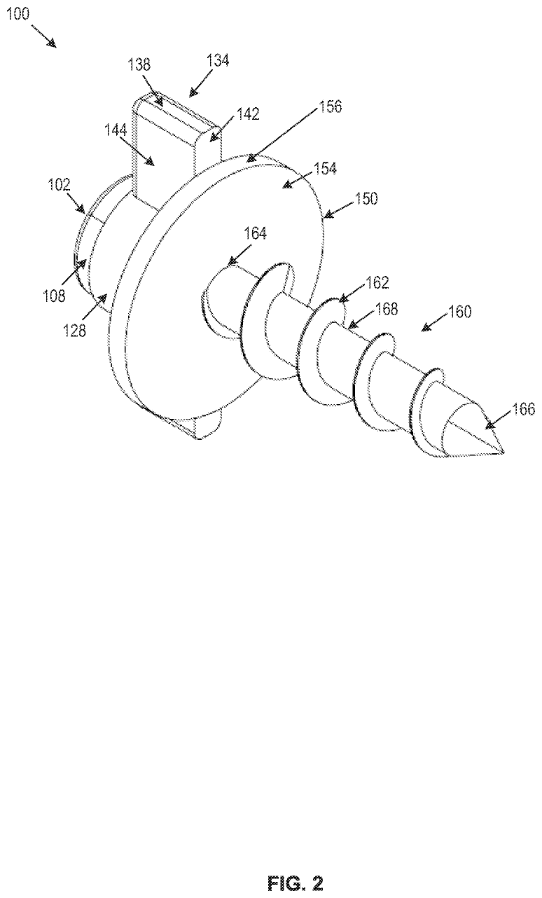

With reference to FIGS. 1 and 2, the fastener washer 150 may include a proximal surface 152 (FIG. 1) and a distal surface 154 (FIG. 2), generally opposite and spaced-apart with one another. In some embodiments, such as the present embodiment, the distal surface 154 may be parallel to the proximal surface 152. An outer edge 156 may extend from the proximal surface 152 to the distal surface 154. In some embodiments, the proximal surface 152 may be disposed at the distal edge 126 of the collar 122.

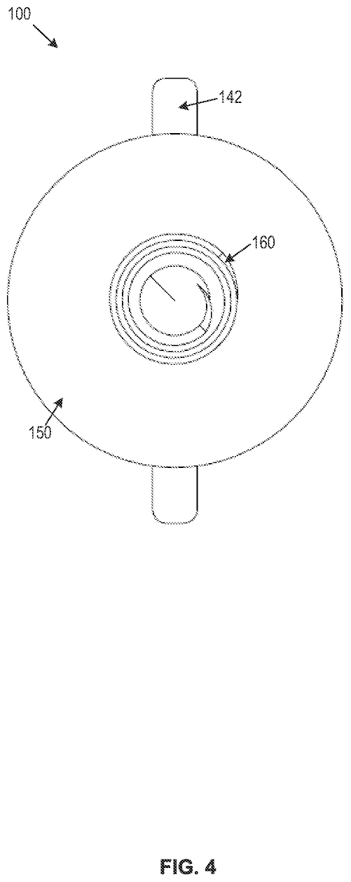

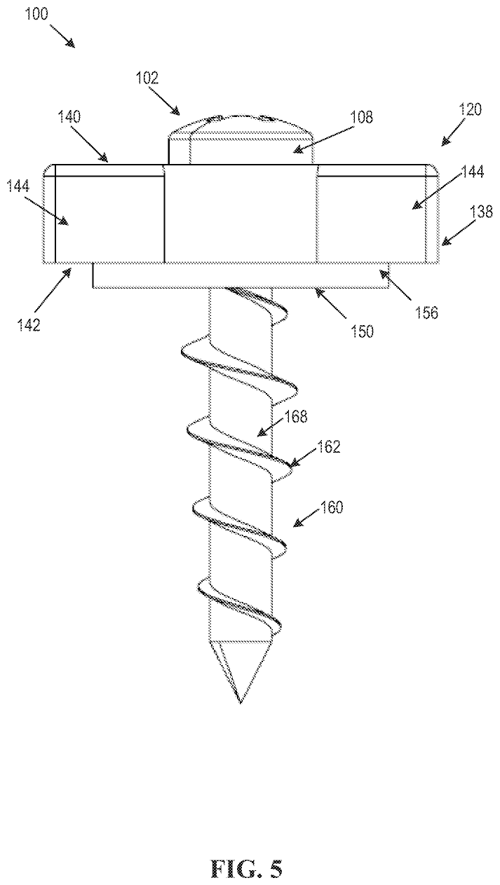

As best shown in FIGS. 3-5, in some embodiments, the fastener washer 150 may have a width or diameter which is greater than a width or diameter of the fastener head 102. The outer edge 156 of the fastener washer 150 may be disposed farther radially outward than the sidewall 108 of the fastener head 102.

With continued reference to FIGS. 3-5, in some embodiments, such as the present embodiment, each fastener wing 134 of the wing assembly 120 may have a radial width or dimension which is greater than the radius of the fastener washer 150. Each fastener wing 134 may extend radially outwardly beyond the outer edge 156 of the fastener washer 150, with the outer edge 138 of the fastener wing 134 disposed radially outwardly beyond the outer edge 156 of the fastener washer 150. In another embodiment, each fastener wing 134 of the wing assembly 120 may have a radial width or dimension which is less than the radius of the fastener washer 150.

The threaded portion 160 of the multifunctional fastener 100 may include an elongated shank 168, which may be arranged in a proximal-to-distal, longitudinal direction of the multifunctional fastener 100. The shank 168 may extend from the distal surface 154 of the fastener washer 150. A fastener thread 162 may extend from the shank 168. In a non-limiting example, the fastener thread may be a V-thread.

The shank 168 may have a proximal end 164 and a distal end 166 opposite the proximal end 164. As illustrated in FIG. 2, the proximal end 164 of the shank 168 may be disposed at the distal surface 154 of the fastener washer 150. The fastener thread 162 may extend outwardly from the shank 168 at least partially between the proximal end 164 and the distal end 166.

In some embodiments, the distal end 166 of the shank 168 may be pointed, as illustrated. In other embodiments, the distal end 166 may be blunt or present any other applicable shape. For example, the distal end 166 may be self-tapping or self-threading.

In some embodiments, the fastener thread 162 of the threaded portion 160 may extend along at least part of the distance between the proximal end 164 and the distal end 166 of the shank 168. In some embodiments, the fastener thread 162 may extend along substantially the entire distance from the proximal end 164 to the distal end 166 of the shank 168.

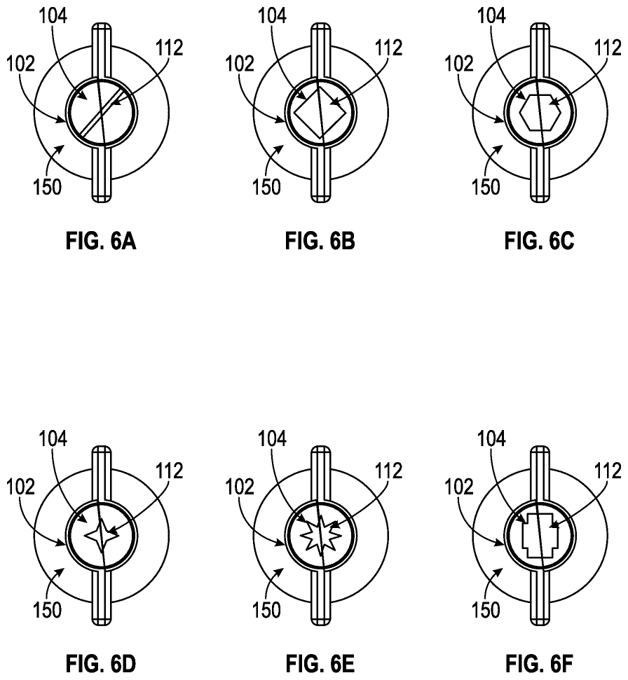

FIGS. 6A-F present side elevation views of various embodiments of the tool connector 112 of the multifunctional fastener 100 of FIG. 1. The tool connector 112 may be female or male, and may present any applicable shape configured for non-rotational coupling with the torque-applying tool, such that rotation of the tool produces a rotation of the fastener head 102. For instance and without limitation, in some embodiments, a female, torque-applying tool connector 112 may include at least indentation to accommodate a torque applying tool. The tool connector 112 may be configured to accommodate a flat blade on the screwdriver, as shown in FIG. 6A. In some embodiments, the torque-applying tool connector 112 may have a square shape as in FIG. 6B, or a hexagonal shape as in FIG. 6C that is configured to accommodate an Allen wrench. In other embodiments, the torque-applying tool connector 112 may have a star shape as shown in FIG. 6D, or a multi-point star as shown in FIG. 6E or a multi-sided cross as shown in FIG. 6F. Other configurations of the tool connector 112, male or female, may also be implemented in the fastener 100.

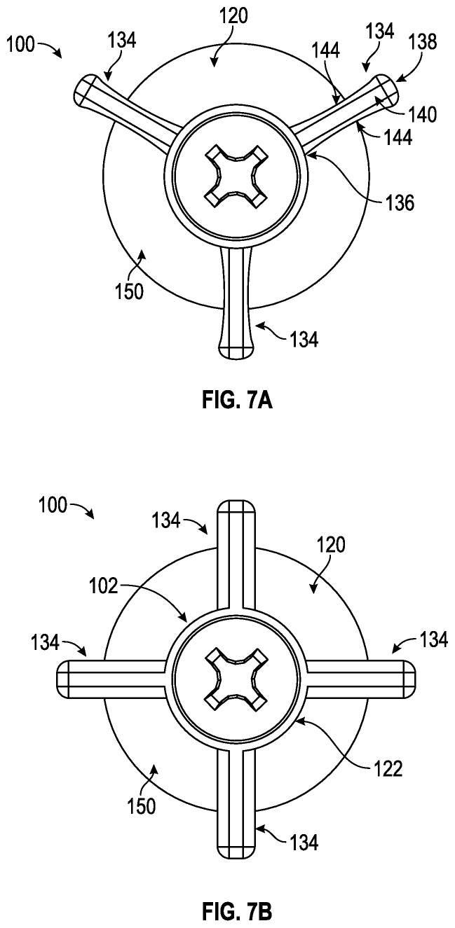

FIG. 7A and FIG. 7B present a side elevation view of an embodiment of the wing assembly 120 of the multifunctional fastener of FIG. 1. The wing assembly 120 comprises one or more wings 134 extending outwardly, and preferably radially outwardly, from the fastener head 102. In some embodiments, such as the present embodiment in FIG. 7A, the wing assembly 120 includes three fastener wings 134, which extend radially outward of the fastener head 102 in angularly-spaced-apart relationship to each other, and more preferably, in a triangular relationship of 60° apart from each other.

The pair of opposite wing sides or side surfaces 144 are bound by the inner edge 136, the outer edge 138, the proximal edge 140 and the distal edge 142 of each fastener wing 134. In some embodiments, such shown in FIG. 7A, one or more of the opposite side surfaces 144 include a non-flat, concave geometry, such as to increase ergonomics. The side surfaces 144 may include a texture or ruggedness, on one or both side surfaces 144, to provide a non-slip grip to the user.

In another embodiment, shown in FIG. 7B, the wing assembly 120 includes four fastener wings 134 disposed in substantially 90-degree relationship to each other, in pairs on opposite sides of the collar 122. The wing assembly 120 may thus include one or more fastener wings 134 in various arrangements and shapes extending radially outward of the fastener head 102.

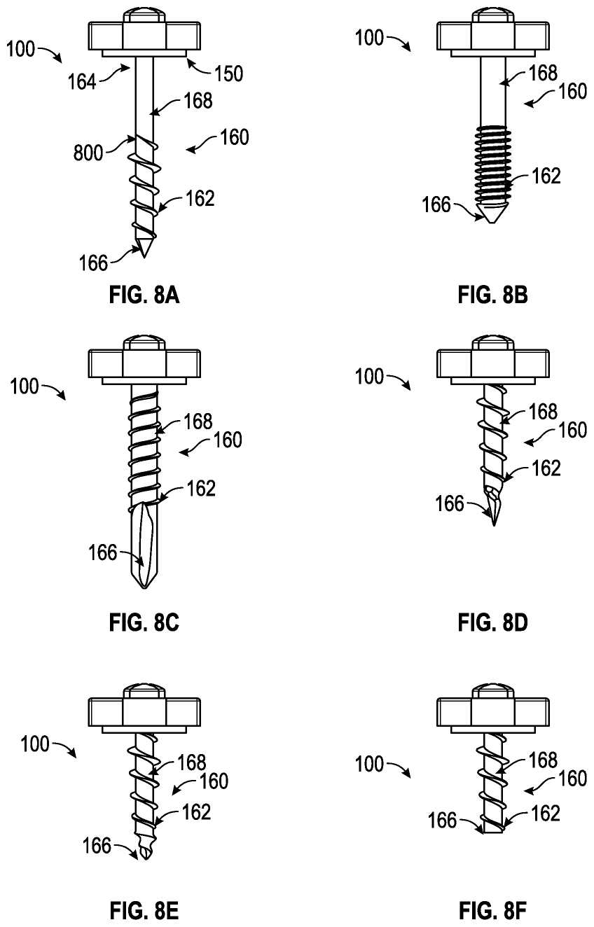

FIGS. 8A-F present distal elevation views of embodiments of the threaded portion 160 of the multifunctional fastener 100 of FIG. 1. The threaded portion 160 of the multifunctional fastener 100 includes an elongated shank 168, which is arranged in a proximal-to-distal, longitudinal direction of the multifunctional fastener 100 with various configurations of fastener threads 162 and distal ends 166. In some embodiments, the distal end 166 of the shank 168 may be pointed, as illustrated in FIGS. 8A-E. The pointed distal ends 166 may have various lengths and have a conical shape or threaded shape, e.g. self-tapping or self-threading. In other embodiments, shown in FIG. 8F, the distal end 166 may be blunt. Thus, the distal ends 166 may be pointed, blunt, threaded, or present any other applicable shape.

The fastener threads 162 form a helical structure around the shank 168. In some embodiments, the fastener thread 162 may extend along substantially the entire distance from the proximal end 164 to the distal end 166 of the shank 168 as shown in FIG. 1 and FIGS. 8D-8F. In some embodiments, the fastener thread 162 of the threaded portion 160 may extend along at least part of the distance between the proximal end 164 and the distal end 166 of the shank 168, as shown in FIGS. 8A and 8B. For example, as shown in FIG. 8A, the fastener thread 162 extends from the distal end 166 to a midpoint 800 of the shank 168, e.g. halfway between the distal end 166 and distal surface 154 of the fastener washer 150.

In some embodiments, the fastener thread 162 may be a V-thread with differing pitches or threads per axial distance. For example, the fastener thread 162 in FIG. 8B has a smaller pitch or more threads per axial distance than the fastener thread 162 in FIG. 8A. In one or more embodiments herein, the fastener threads 162 may have varying widths relative to a diameter of the shank 168.

In the embodiments in FIGS. 8A-F, the shank 168 is configured as a cylinder with a same diameter from the proximate edge 164 until the distal end 166 to form a straight thread. In other embodiments, the shank 168 may be tapered with a first diameter at the proximate edge 164 that narrows to a second diameter at the distal end 166, wherein the first diameter is greater than the second diameter, to form a tapered thread. The fastener 100 may thus include a tapered or straight threaded portion 160 that includes various configurations of fastener threads 162 and ends 166.

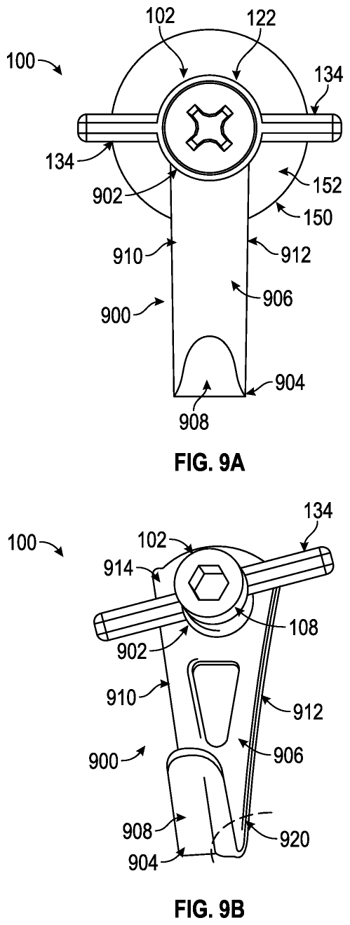

FIG. 9A illustrates a side elevation view of an embodiment of the multifunctional fastener of FIG. 1 with an integrated fastening hook 900. In some embodiments, a fastening hook 900 extends outwardly with respect to the sidewall 108 of the fastener head 102. A proximate edge 902 of the fastening hook 900 is fixedly attached to the fastener 100 between the fastener head 102 and the threaded portion 160. A distal edge 904 of the hook 900 curves distally outward and/or upwards to form a hooking end 908.

The fastening hook 900 may include a proximal surface 906 and a distal surface (not shown), generally opposite and spaced-apart with one another. In some embodiments, such as the present embodiment, the distal surface of the fastening hook 900 is parallel to the proximal surface 906 and relatively flat. A first outer edge 910 and a second outer edge 912 extends from the proximal surface 906 to the distal surface of the fastening hook 900. The first outer edge 910 and the second outer edge 912 may be parallel or may angle with respect to each other to decrease a width of the proximal surface 906 at the distal edge 904 from that of the proximate edge 902. The sidewall 108 and the collar 122 extend distally from the proximal surface 906 at the proximate edge 902 of the fastening hook.

The hooking end 908 bends or curves distally outward and/or upwards from the proximal surface 906 to form the hook at the distal edge 904. An angle 920 measured between the hooking end 908 and the proximal surface 906 is preferably 90 degrees or less.

In some embodiments, the fastening hook 900 may be fabricated in one piece with the washer 150 and the sidewall 108 of the fastener head 102. In some embodiments, the fastening hook 900 may be fabricated in one piece with the collar 122 of the wing assembly 120. In some embodiments, the fastening hook 900 may be fixedly attached to the sidewall 108 of the fastener head 102 or the collar 122 of the wing assembly 120 using a ring collar formed in the proximate edge 902 that fits around the sidewall 108 or the collar 122. In other embodiments, the fastening hook 900 may be attached to the sidewall 108 of the fastener head 102 or the collar 122 of the wing assembly 120 using welding and/or other attachment technique.

FIG. 9B illustrates a side elevation view of another embodiment of the multifunctional fastener 100 of FIG. 1 with an integrated fastening hook 900. In this embodiment, the fastener 100 does not include the washer 150 but rather the fastening hook 900 includes a face 914 fixedly attached between the fastener head 102 and the threaded portion 160. The face 914 includes a width which is greater than a width or diameter of the fastener head 102 such that the face 914 extends farther outward than the sidewall 108 of the fastener head 102. The sidewall 108 extends distally from the proximal surface 906 of the face 914 of the fastening hook 900. The fastening hook 900 may be fabricated in one piece with the sidewall 108 of the fastener head 102.

As shown in FIG. 9B, in one or more embodiments, the wings 134 are fixedly attached to the sidewall 108 of the fastener head 102. The wings 134 may be fabricated in one piece with the collar 122 of the wing assembly 120 or attached via welding or other attachment means to the fastener head 102.

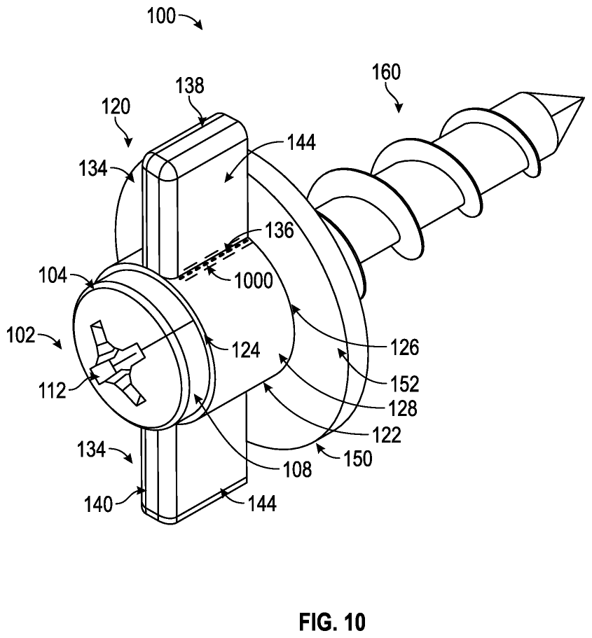

FIG. 10 presents a proximal, isometric view of the multifunctional fastener of FIG. 1 with a detachable wing assembly 134. In some embodiments, the fastener wings 134 of the wing assembly 120 may be detachable from the collar 122. For example, the fastener wing 134 of the wing assembly 120 may include a perforation line 1000 that extends along the junction between the outer surface 128 of the collar 122 and an edge 136 of the fastener wing 134. The perforation line 1000 weakens the attachment of the fastener wing 134 to the collar 122. The fastener wing 134 may thus be detachable from the collar 122 using one or more hinging forces to bend the wing 134 along the perforation line 1000.

In another embodiment, the collar 122 of the wing assembly 120 is detachable from the sidewall 108 of the fastener head 102. The wing assembly 120 may include threads on the inner wall of the collar 122 that attaches to threads on the sidewall 108 of the fastener head 102 so that the wing assembly 120 may be twisted or screwed onto the fastener head 102. In another embodiment, the collar 122 is fabricated from an elastic material that stretches to encircle the sidewall 108 of the fastener head 102. The wing assembly 120 may be removed by stretching or extending the elastic collar 122 from the fastener head 102.

In an illustrative application of the multifunctional fastener of the present disclosure, a supply of the multifunctional fasteners 100 may be placed in a storage container (not illustrated) such as, but not limited to, a toolbox or kit. In some applications, the multifunctional fasteners 100 may be organized according to size, configuration and/or material of construction according to the preferences and tastes of a user (not illustrated). Each multifunctional fastener 100 may be suitably configured to attach or secure a material to be fastened to a support for the material.

In some applications, the user of the multifunctional fastener 100 may first drill a fastener opening (not illustrated) in the material to be fastened and in the support to which the material will be fastened. The threaded portion 160 may be inserted through the fastener opening in the material and threaded into the registered fastener opening in the support. In some applications, this may be accomplished by manual or digital application of a torque to the side surfaces 144 on the fastener wings 134 of the wing assembly 120, such as in the clockwise direction. The shank 168 and the fastener threads 168 of the threaded portion 160 may be rotated via the fastener head 102 and the fastener washer 150 until the distal surface 154 of the fastener washer 150 engages the outer surface of the fastened material.

In some applications, it may be necessary to apply a screwdriver or other torque-applying tool (not illustrated) to the fastener head 102 to rotate the threaded portion 160. The screwdriver blade on the screwdriver may be inserted in the torque-applying tool connector 112. The screwdriver may be rotated in the clockwise (or counterclockwise) direction to correspondingly rotate the multifunctional fastener 100, and thus the threaded portion 160, and drive the shank 168 and the fastener threads 162 into the fastener opening.

In some applications, it may be necessary for the multifunctional fastener 100 to be removed from the fastener openings in the fastened material and the support. The threaded portion 160 may be rotated, in the counterclockwise direction, by manual or digital application of a counterclockwise torque to the fastener wings 134 of the wing assembly 120. Alternatively, the screwdriver or other torque-applying tool may be used to rotate the multifunctional fastener 100 by engagement of the tool with the torque-applying tool connector 112.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A multifunctional fastener, comprising:
a fastener head;
a threaded portion arranged in a proximal-to-distal, longitudinal direction and arranged distally of the fastener head; and
a wing assembly including at least one fastener wing extending radially outward from the fastener head.

2. The multifunctional fastener of claim 1, further comprising:
a fastener washer integrated between the fastener head and the threaded portion, the fastener washer extending radially outward of the fastener head.

3. The multifunctional fastener of claim 2, further comprising:
a torque-applying tool connector formed in the fastener head, wherein the torque-applying tool connector is configured for engagement with a torque-applying tool to facilitate rotation of the threaded portion via the fastener head.

4. The multifunctional fastener of claim 2, wherein the wing assembly comprises:
a collar attached around an outer wall of the fastener head; and
a plurality of the fastener wings attached to the collar, each extending radially outward beyond an outer edge of the fastener washer.

5. The multifunctional fastener of claim 4, wherein each of the plurality of fastener wings comprises:
a pair of opposite wing side surfaces, wherein one or both of the wing side surfaces includes a convex geometry.

6. The multifunctional fastener of claim 5, wherein one or both of the wing side surfaces includes a slip decreasing, non-smooth texture.

7. The multifunctional fastener of claim 5, wherein each of the plurality of fastener wings is detachable and comprises:
a perforation line that extends along a junction between an outer surface of the collar and an inner edge of the fastener wing, wherein the perforation line weakens an attachment of the fastener wing to the collar.

8. The multifunctional fastener of claim 1, further comprising:
a fastening hook integrated between the fastener head and the threaded portion, wherein the fastening hook extends outwardly with respect to a sidewall of the fastener head.

9. The multifunctional fastener of claim 8, wherein the fastening hook comprises:
a proximate edge disposed between the fastener head and the threaded portion; and
a distal edge with a hooking end.

10. A fastener, comprising:
a fastener head;
a threaded portion arranged in a proximal-to-distal, longitudinal direction and arranged distally of the fastener head; and
a wing assembly fixedly attached to the fastener head, wherein the wing assembly includes a plurality of fastener wings extending radially outward from the fastener head.

11. The fastener of claim 10, wherein the wing assembly comprises:
a collar attached around an outer wall of the fastener head, wherein the plurality of the fastener wings are attached to the collar.

12. The fastener of claim 11, wherein each of the plurality of fastener wings comprises:
a pair of opposite wing side surfaces, wherein one or both of the wing side surfaces includes a convex geometry.

13. The fastener of claim 12, wherein one or both of the wing side surfaces includes a slip decreasing, non-smooth texture.

14. The fastener of claim 11, wherein each of the plurality of fastener wings is detachable and comprises:
a perforation line that extends along a junction between an outer surface of the collar and an inner edge of the fastener wing, wherein the perforation line weakens an attachment of the fastener wing to the collar.

15. The fastener of claim 11, wherein the plurality of the fastener wings are attached to the fastener head.

16. The fastener of claim 10, further comprising:
a fastening hook integrated between the wing assembly and the threaded portion, wherein the fastening hook extends outwardly with respect to a sidewall of the fastener head.

17. The fastener of claim 16, wherein the fastening hook comprises:
a proximate edge disposed between the fastener head and the threaded portion; and
a distal edge with a hooking end.

18. The multifunctional fastener of claim 17, further comprising:
a fastener washer integrated between the fastener head and the threaded portion, the fastener washer extending radially outward of the fastener head.

19. A fastener, comprising:
a fastener head;
a threaded portion arranged in a proximal-to-distal, longitudinal direction and arranged distally of the fastener head;
a wing assembly fixedly attached to the fastener head, wherein the wing assembly includes a plurality of fastener wings extending radially outward from the fastener head; and
a fastener washer fixedly attached between the wing assembly and the threaded portion, the fastener washer extending radially outward of the fastener head.

20. The fastener of claim 19, further comprising:
a fastening hook integrated between the wing assembly and the threaded portion, wherein the fastening hook extends outwardly with respect to a sidewall of the fastener head.
